(19) United States
(12) Patent Application Publication
(10) Pub. No.: US 2026/0158868 A1
(43) Pub. Date: Jun. 11, 2026

(54) REFRIGERANT LINE FREEZE PREVENTION IN CLIMATE CONTROL SYSTEMS

(71) Applicant: FCA US LLC, Auburn Hills, MI (US)

(72) Inventors: Xiaozhou Jiang, Shanghai (CN); Junjie Zhou, Shanghai (CN); Zuohong Fu, Shanghai (CN); Haifeng Guo, Shanghai (CN); Hongyu Wang, Shanghai (CN)

(21) Appl. No.: 18/974,944

(22) Filed: Dec. 10, 2024

(51) Int. Cl. B60H 1/32

(52) U.S. Cl. CPC B60H 1/321; B60H 2001/3263; B60H 2001/3272; B60H 2001/3282

(57) ABSTRACT

A climate control system for a vehicle with a compressor and an evaporator coupled to the compressor; the evaporator has a refrigerant line coupled thereto. The system has a blower disposed proximate the evaporator and a temperature sensor proximate the evaporator which generates a temperature signal corresponding to a temperature of the refrigerant line. There, a controller is coupled to the compressor, blower, and temperatures sensor which is programmed to control the compressor, blower, and temperature sensor. The controller decreases a speed of the blower when the temperature signal is below a first temperature threshold. The controller stops the compressor when the temperature signal is below a second temperature threshold where the second temperature threshold is less than the first temperature threshold.

### FIELD

The present disclosure relates to climate control systems in vehicles and, more particularly, to a method and system to prevent refrigerant lines from freezing.

### BACKGROUND

This section provides background information related to the present disclosure which is not necessarily prior art.

Climate control systems in vehicles are used to regulate the temperature within the passenger compartment of a vehicle. Refrigerant flows through refrigerant lines and into an evaporator to absorb heat from air which blows over evaporator coils and into the passenger compartment.

### SUMMARY

This section provides a general summary of the disclosure and is not a comprehensive disclosure of its full scope or all of its features.

Climate control systems in vehicles are at risk of freezing during long durations of operation. The present disclosure recognizes that refrigerant line freezing can be prevented by decreasing the speed of the blower and turning off the compressor if the temperature signal measured at the refrigerant line decreases below a threshold temperature.

In one example, a climate control system includes an evaporator and a temperature sensor proximate the evaporator and configured to measure a temperature signal of a refrigerant line. The climate control system includes a compressor configured to compress refrigerant. The climate control system includes a blower configured to blow air, which flows over the evaporator, into the passenger compartment. The climate control system includes a controller coupled to the temperature sensor, the compressor, and the blower. The controller receives the temperature signal from the temperature sensor and compares it to a temperature threshold to determine if a refrigerant line will freeze. The controller operates the blower to reduce a speed of the blower to prevent the refrigerant line from freezing. The controller also turns off and turns on the compressor to prevent the refrigerant line from freezing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected examples and not all possible implementations, and are not intended to limit the scope of the present disclosure.

FIG. 1 is a top-down cutaway view of a vehicle with a climate control system configured to prevent refrigerant lines from freezing.

FIG. 2 is a diagrammatic schematic view of the climate control system and the interconnection of refrigerants lines to components of the climate control system as well as the connections of a controller to the components of the climate control system illustrated in FIG. 1.

FIG. 3 is a block diagrammatic view illustrating the climate control system of FIG. 1.

FIG. 4 is a flow diagram of a method of operating the climate control system.

FIG. 5A illustrates an example of the user interface and the user display.

FIG. 5B illustrates an example of the user interface.

FIG. 5C illustrates an example of the user interface and the user display.

Corresponding reference numerals indicate corresponding parts throughout the several views of the drawings.

### DETAILED DESCRIPTION

As described above, prior to the present disclosure, there was a lack of solutions for preventing refrigerant lines in a vehicle from freezing. Frozen refrigerant lines in a vehicle would prevent a climate control system from blowing cool air through air ducts into a passenger compartment. The present disclosure encompasses a solution to frozen refrigerant lines by comparing a temperature signal to multiple temperature thresholds to control a compressor and a blower to prevent refrigerant lines from freezing. The climate control system prevents the refrigerant lines from freezing, thus allowing the climate control system to continue to deliver cooled air to the passenger compartment. In some examples, a user display displays a notification to increase the temperature in the vehicle. In other examples, a vent allows outside air to enter the vehicle to heat the frozen refrigerant lines.

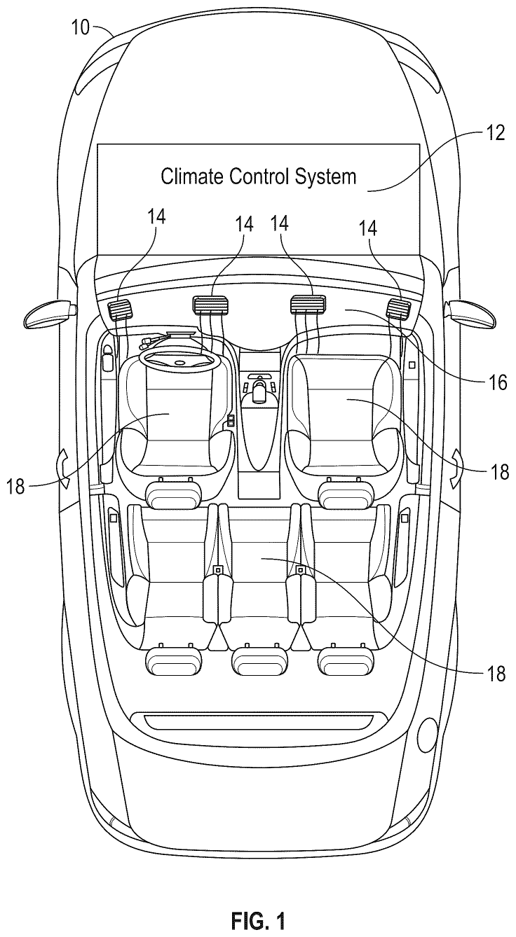

Referring to FIG. 1, a block diagrammatic view shows a vehicle 10. A climate control system 12 is disposed in the vehicle 10. The climate control system 12 may be located proximate one or more duct outlets 14. A passenger compartment 16 has seats 18 for vehicle occupants. The climate control system 12 communicates conditioned air through the duct outlets 14 into the passenger compartment 16 of the vehicle 10.

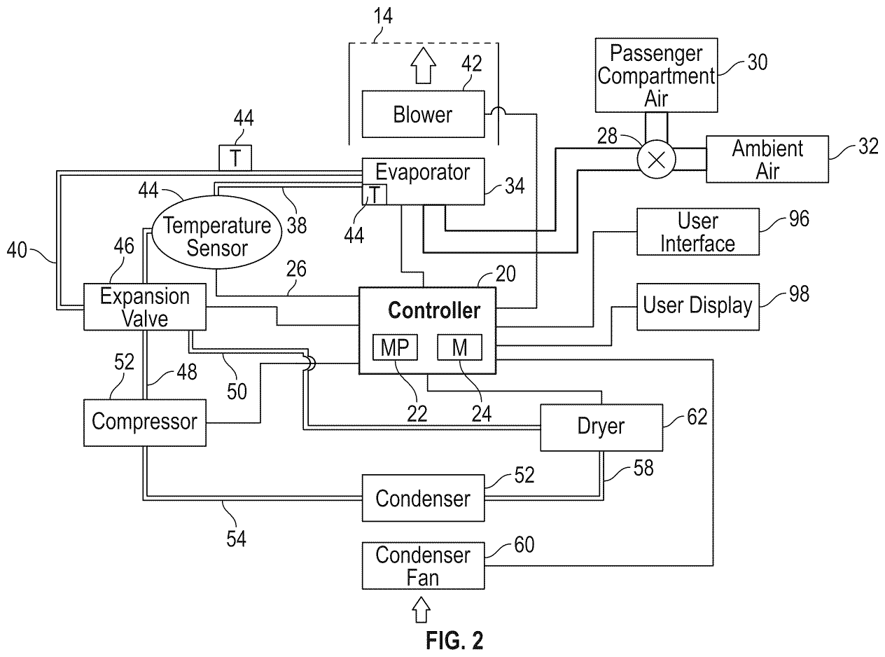

Referring now to FIG. 2, a diagrammatic view of an example of the climate control system 12 illustrates the interconnection of refrigerants lines and components of the climate control system 12. A controller 20 coupled to the components of the climate control system 12 is also shown. The controller 20 has a microprocessor 22 or is processor based. The controller 20 is coupled to a memory 24 that is a non-transitory machine-readable medium that is executable by the microprocessor 22 and the memory 24. The climate control system 12 is configured to prevent a frozen refrigerant line and to reduce hot air from blowing into the passenger compartment 16.

The duct outlets 14 are coupled to a valve. The valve 28 is selectively positioned to take in passenger compartment air 30, ambient air 32, or a combination of both. The passenger compartment air 30 and the ambient air 32 flow over an evaporator 34.

The evaporator 34 is coupled to an inlet evaporator refrigerant line 38 and an outlet evaporator refrigerant line 40. A liquid refrigerant flows through the inlet evaporator refrigerant line 38 and into the evaporator 34. The liquid refrigerant boils and turns into a gas refrigerant as it flows through the evaporator coils 36. As the passenger compartment air 30 and the ambient air 32 flow over the evaporator 34, the gas refrigerant absorbs heat from the passenger compartment air 30 and the ambient air 32. A blower 42 blows newly cooled air into the passenger compartment 16.

In one example, a temperature sensor 44 is coupled to the inlet evaporator refrigerant line 38. The temperature sensor 44 generates a temperature signal 26 corresponding to the temperature of the inlet evaporator refrigerant line 38. However, in other examples, the temperature sensor 44 may be coupled to the evaporator coils or the outlet evaporator refrigerant line 40. The temperature sensor 44 in determining the temperature proximate the evaporator 34 detects a refrigerant line at risk of freezing or which has already frozen.

The inlet evaporator refrigerant line 38 and the outlet evaporator refrigerant line 40 are coupled to an expansion valve 46. The expansion valve 46 regulates the flow of liquid refrigerant into the evaporator 34 through the inlet evaporator refrigerant line 38. The expansion valve 46 is coupled to an inlet compressor refrigerant line 48 and an outlet dryer refrigerant line 50.

A compressor 52 is coupled to the inlet compressor refrigerant line 48 and an outlet compressor refrigerant line 54. The compressor 52 pressurizes the gas refrigerant, then sends the gas refrigerant to the outlet compressor refrigerant line 54.

A condenser 56 is coupled to the outlet compressor refrigerant line 54 and an outlet condenser refrigerant line 58. The condenser 56 receives pressurized gas refrigerant from the outlet compressor refrigerant line 54, which flows through the condenser 56. The pressurized gas refrigerant cools down into a liquid refrigerant as a condenser fan 60 blows external air over the condenser 56. The condenser 56 sends the liquid refrigerant though the outlet condenser refrigerant line 58.

A dryer 62 is coupled to the outlet condenser refrigerant line 58 and the outlet dryer refrigerant line 50. The dryer 62 removes water from the liquid refrigerant. Afterward, the dryer sends the liquid refrigerant through the outlet dryer refrigerant line 50 and into the expansion valve 46.

The controller 20 of the climate control system 12 is coupled to the temperature sensor 44. The controller 20 is generally configured to detect whether the temperature signal received from the temperature sensor 44 has increased above or decreased below the temperature thresholds.

The controller 20 is coupled to the compressor 52 and generates a compressor signal that turns on or off the compressor 52.

The controller 20 is coupled to the blower 42 and generates a blower signal that turns on or off the blower 42 or adjusts a speed of the blower 42.

The controller 20 is coupled to the expansion valve 46 and generates an expansion valve signal that controls the flow of refrigerant into the evaporator 34.

The controller 20 is coupled to the dryer 62 and generates a dryer signal 72 that regulates the operation of the dryer 62 which removes water from the refrigerant.

The controller 20 is coupled to the condenser 56 and generates a condenser signal that regulates the operation of the condenser 56 which reduces the temperature of the refrigerant and changes the refrigerant from a gas state to a liquid state.

The controller 20 is coupled to the condenser fan 60 and generates a condenser fan signal that turns on or off the condenser fan 60 or controls a variable condenser fan speed.

The controller 20 is coupled to the evaporator 34 and generates an evaporator signal that regulates the operation of the evaporator 34 which changes the refrigerant from a liquid state to a gas state. The refrigerant in a gas state absorbs heat from the air that blower 42 blows over the evaporator 34.

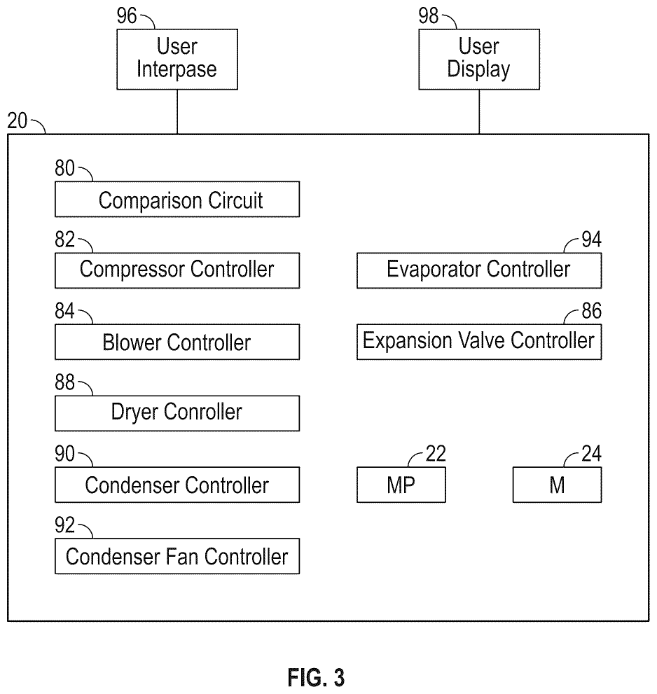

Referring now also to FIG. 3, an example of the components comprising the controller 20. The controller 20 in this example includes a comparison circuit 80, a compressor controller 82, a blower controller 84, an expansion valve controller 86, a dryer controller 88, a condenser controller 90, a condenser fan controller 92, and an evaporator controller 94.

A user interface 96 such as a blower speed dial and a temperature dial. A user display 98 may be an LCD display, which may act as a user interface 96 when the display 98 is a touch screen display.

The comparison circuit 80 compares the temperature signal to the temperature thresholds and generates an output signal corresponding to the comparison.

The compressor controller 82 generates the compressor signal that turns on or off the compressor 52 based on the comparison signal.

The blower controller 84 generates the blower signal that turns on or off the blower 42 or adjusts the speed of the blower 42 based on the comparison signal.

The expansion valve controller 86 generates the expansion valve signal that controls the flow of refrigerant into the evaporator 34.

The dryer controller 88 generates the dryer signal that regulates the dryer 62.

The condenser controller 90 generates the condenser signal that regulates the condenser 56.

The condenser fan controller 92 generates the condenser fan signal that turns on or off the condenser fan 60.

The evaporator controller 94 generates the evaporator signal that regulates the evaporator 34.

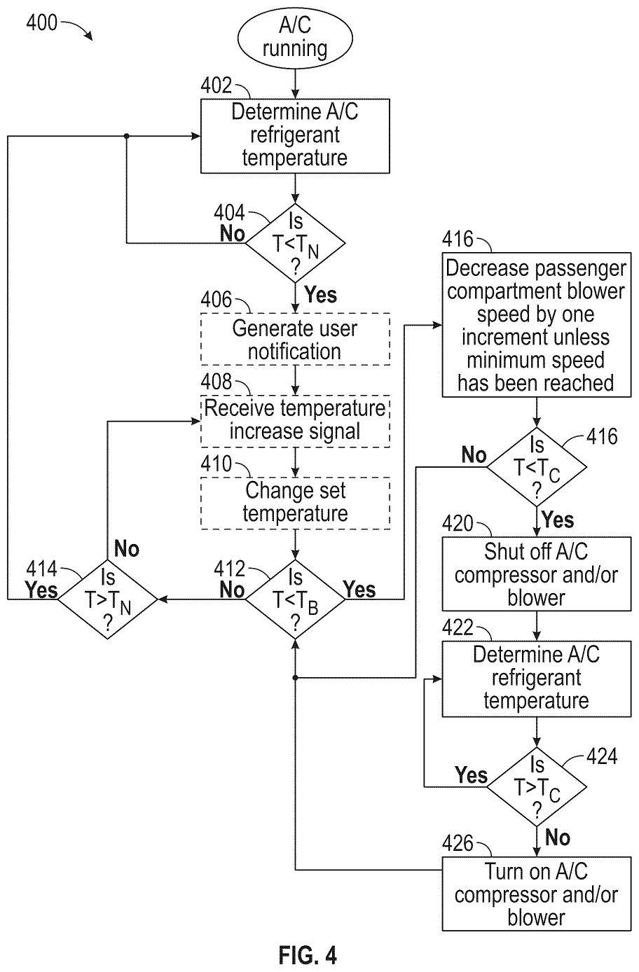

Referring now to FIG. 4, a flow diagram of an example of the climate control system 12 for detecting whether a temperature in the passenger compartment 16 is above or below the temperature thresholds is set forth.

At step 402, the controller 20 receives a temperature signal from the temperature sensor 44 that corresponds to the temperature T of the evaporator, the input refrigerant line or the output refrigerant line.

At step 404, the controller 20 compares the temperature signal to a notification temperature threshold T_{N}. For example, the notification temperature threshold T_{N} may be 4° C. If the temperature signal is above the notification temperature threshold, then step 402 is performed. If the temperature signal is below the notification temperature threshold T_{N}, then step 406 is performed.

At step 406, the controller 20 generates a user notification 102 to convey to a user that the refrigerant line or evaporator is at risk of freezing and that the user should increase the temperature in the passenger compartment 16.

At step 408, the controller 20 may receive a temperature control signal from the user interface 96 to change the temperature in the passenger compartment 16.

At step 410, the controller 20 changes the temperature in the passenger compartment 16 based on the temperature control signal 104.

At step 412, the controller 20 compares the temperature signal to a blower temperature threshold T_{B}. For example, the blower temperature threshold may be 2° C. If the temperature signal 26 is above the blower temperature threshold T_{B}, then step 414 is performed. If the temperature signal is below the blower temperature threshold, then step 416 is performed.

At step 414, the controller 20 compares the temperature signal to the notification temperature threshold. If the temperature signal is above the notification temperature threshold T_{N}, then step 402 is performed. If the temperature signal is below the notification temperature threshold T_{N}, then step 408 is performed.

At step 416, the controller 20 decreases the speed of the blower 42 by one increment unless the minimum speed of the blower 42 has been reached. If the minimum speed of the blower 42 has been reached, step 418 is performed.

At step 418, the controller 20 compares the temperature signal to a compressor temperature threshold. For example, the compressor temperature threshold may be 0° C. If the temperature signal is above the compressor temperature threshold, then step 412 is performed. If the temperature signal 26 is below the compressor temperature threshold, step 420 is performed.

At step 420, the controller 20 shuts off the compressor 52 and/or the blower 42.

At step 422, the controller 20 receives an additional temperature signal T from the temperature sensor 44.

At step 424, the controller 20 compares the additional temperature signal to the compressor temperature threshold T_{C}. If the additional temperature signal 26 is below the compressor temperature threshold, step 422 is performed. If the temperature signal T is above the compressor temperature threshold T_{C}, step 426 is performed.

At step 426, the controller 20 starts the compressor 52 and/or the blower 42, then step 412 is performed.

In another example, at step 416, the controller 20 opens the valve 28. The controller 20 controls the blower 42 to blow the ambient air 32 through the valve 28.

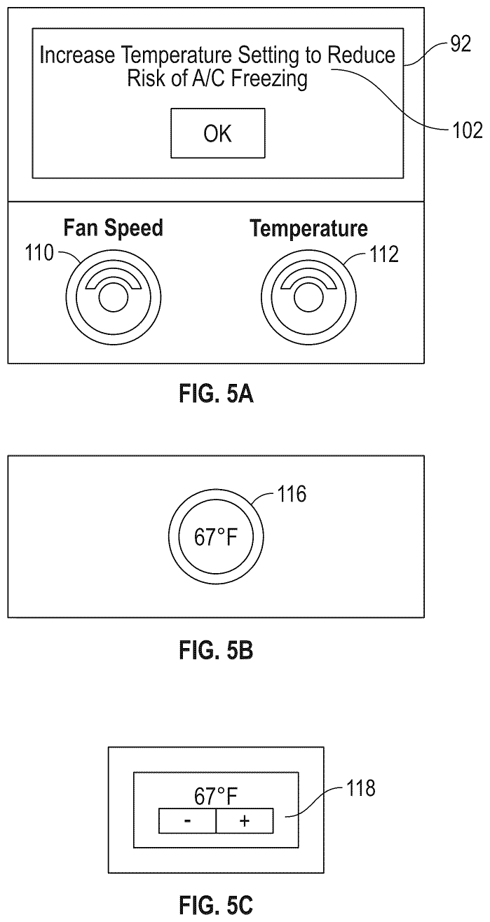

FIG. 5A illustrates an example of the user interface 96 and the user display 98. The user display 98 displays the user instruction notification 102 generated by the controller 20 which conveys to the user that the user should increase the temperature in the passenger compartment 16 to reduce the risk of the refrigerant line or evaporator freezing. There is a first dial 110 and a second dial 112 below the user display 98. The first dial 110 controls the speed of the blower 42 by transmitting a blower control signal to the controller 20. The second dial 112 is a temperature user interface and controls a temperature in the passenger compartment 16 by transmitting a temperature control signal to the controller 20.

FIG. 5B illustrates another example of the user interface 96 and the user display 98. This example has a dial 116 to control the speed of the blower 42 by sending a blower control signal to the controller 20 and to control the temperature in the passenger compartment 16 by sending a temperature control signal to the controller 20.

FIG. 5C illustrates another example of the user interface 96 and the user display 98. This example uses a touchscreen 118 to control the speed of the blower 42 by sending a blower control signal to the controller 20 and to control the temperature in the passenger compartment 16 by sending a temperature control signal to the controller 20.

Example examples are provided so that this disclosure will be thorough, and will fully convey the scope to those who are skilled in the art. Numerous specific details are set forth such as examples of specific components, devices, and methods, to provide a thorough understanding of examples of the present disclosure. It will be apparent to those skilled in the art that specific details need not be employed, that example examples may be embodied in many different forms and that neither should be construed to limit the scope of the disclosure. In some example examples, well-known processes, well-known device structures, and well-known technologies are not described in detail.

The terminology used herein is for the purpose of describing particular example examples only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example examples.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A climate control system for a vehicle, comprising:
a compressor;
an evaporator coupled to the compressor, the evaporator having a refrigerant line coupled thereto;
a blower disposed proximate the evaporator;
a temperature sensor proximate the evaporator and generates a temperature signal corresponding to a temperature of the refrigerant line; and
a controller coupled to the compressor, blower, and temperatures sensor, programmed to control the compressor, blower, and temperature sensor, the controller decreases a speed of the blower when the temperature signal is below a first temperature threshold and stops the compressor when the temperature signal is below a second temperature threshold where the second temperature threshold is less than the first temperature threshold.

2. The system of claim 1 wherein the controller starts compressor when the temperature signal increases from below the second temperature threshold to above the second temperature threshold.

3. The system of claim 1 wherein the controller increases a speed of the controller after the temperature signal increases from below the second temperature threshold to above the second temperature threshold.

4. The system of claim 1 wherein the controller incrementally decreases the speed of the blower when the temperature signal is below the first temperature threshold.

5. The system of claim 1 further comprising:
an input refrigerant line or output refrigerant line coupled to the evaporator and to the temperature sensor.

6. The system of claim 1 wherein the controller controls a display to display an instruction notification to increase a temperature inside a passenger compartment of the vehicle when the temperature signal is below a third temperature threshold where the third temperature threshold is greater than or equal to the first temperature threshold.

7. The system of claim 1 further comprising:
a temperature user interface transmitting a temperature control signal to the controller.

8. The system of claim 7 wherein the controller receives the temperature control signal and changes a temperature setting.

9. The system of claim 8 further comprising:
the controller generating a blower speed control signal in response to the temperature control signal.

10. The system of claim 1 further comprising:
an expansion valve coupled to the compressor.

11. The system of claim 1 further comprising:
a vent coupled to the controller, the controller controlling the blower to communicate ambient air through the vent when the temperature signal is below the second temperature threshold.

12. A method for controlling a climate control system for a vehicle, comprising the steps of:
generating a temperature signal corresponding to a temperature of a refrigerant line;
decreasing a speed of a blower when the temperature signal is below a first temperature threshold; and
stopping a compressor when the temperature signal is below a second temperature threshold where the second temperature threshold is less than the first temperature threshold.

13. The method of claim 12 further comprising starting a compressor in response to the temperature signal increasing from below the second temperature threshold to above the second temperature threshold.

14. The method of claim 12 further comprising increasing the speed of the blower in response to the temperature signal increasing from below the second temperature threshold to above the second temperature threshold.

15. The method of claim 12 further comprising incrementally decreasing the speed of the blower in response when the temperature signal is below the first temperature threshold.

16. The method of claim 12 further comprising displaying an instruction notification to increase a temperature inside a passenger compartment of the vehicle when the temperature signal is below a third temperature threshold where the third temperature threshold is greater than or equal to the first temperature threshold.

17. The method of claim 12 further comprising transmitting a temperature control signal from a temperature user interface to a controller.

18. The method of claim 17 further comprising receiving the temperature control signal and changing a temperature setting.

19. The method of claim 18 further comprising generating a blower speed control signal in response to the temperature control signal.

20. The method of claim 12 further comprising blowing ambient air through a vent when the temperature is below the second temperature threshold.
